(19) United States
(12) Patent Application Publication
(10) Pub. No.: US 2004/0266402 A1
(43) Pub. Date: Dec. 30, 2004

(54) Apparatus and method for message control on a wireless communication device

(76) Inventor: Mary J. Schavitz, Vemon Hills, IL (US)

Correspondence Address: MOTOROLA INC, 600 NORTH US HIGHWAY 45, ROOM AS437, LIBERTYVILLE, IL, 60048-5343, US

(21) Appl. No.: 10/609,758

(22) Filed: Jun. 30, 2003

(51) Int. Cl. H04M 3/42

(52) U.S. Cl. 455/412.2; 455/466; 455/415

(57) ABSTRACT

An apparatus and method of messaging service message control on a wireless communication device. At least one phone number can be stored in a phone book located in the memory of the mobile communication device. A status of an incoming message acceptance indicator in the mobile communication device is set to indicate an incoming message filtering status. An incoming messaging service based message is received from a wireless messaging system, the incoming messaging service based message including a phone number of the originator of the messaging service based message. The phone number of the originator of the messaging service based message is compared with the phone book located in the memory of the mobile communication device. The incoming messaging service based message is displayed only if the phone number of the originator is present in the phone book located in the memory of the mobile communication device.

### BACKGROUND

1. Field

The present disclosure is directed to a method and apparatus for wireless message control. More particularly, the present disclosure is directed to messaging service message control using an phone book on a wireless communication device.

2. Description of Related Art

Presently, messaging service based messages can be sent between electronic devices across a wireless network. Such messaging service based messages can include short message service (SMS) messages, enhanced messaging service (EMS) messages, multimedia messaging service messages (MMS), and the like. For example, a user of a mobile phone can send a messaging service based message to a user of another mobile phone. This can be useful for sending quick messages. This can also be useful for sending messages when a user is unable to talk, such as when a user is in a theater or library.

Unfortunately, a user of a mobile communication device may not want to receive unsolicited messages. For example, the user may not want to receive advertisements or obscene messages from unknown sources. This can be a dangerous problem for minors such as children. Especially because minors may be more susceptible to advertisements than adults. Also, obscene messages can be particularly harmful to children. Furthermore, a child may respond to an unsolicited message from a predator by using a “Reply” function or by calling an included phone number. After the child responds, the predator may then attempt to coerce the child to revealing their location.

Thus, there is a need for messaging service message control in a wireless communication device.

### BRIEF DESCRIPTION OF THE DRAWINGS

The preferred embodiments of the present invention will be described with reference to the following figures, wherein like numerals designate like elements, and wherein:

FIG. 1 is an exemplary block diagram of a system according to one embodiment;

FIG. 2 is an exemplary block diagram of a mobile communication device according to one embodiment;

FIG. 3 is an exemplary flowchart illustrating the operation of a mobile communication device according to one embodiment; and

FIG. 4 is an exemplary flowchart illustrating the operation of a mobile communication device according to another embodiment.

### DETAILED DESCRIPTION OF PREFERRED EMBODIMENTS

The disclosure provides an apparatus and method of messaging service message control on a wireless communication device. The method can include storing at least one phone number in an phone book located in the memory of the mobile communication device, setting a status of an incoming message acceptance indicator in the mobile communication device to indicate an incoming message filtering status, receiving an incoming messaging service based message from a wireless messaging system, the incoming messaging service based message including a phone number of the originator of the messaging service based message, comparing the phone number of the originator of the messaging service based message with the phone book located in the memory of the mobile communication device, and displaying the incoming messaging service based message only if the phone number of the originator is present in the phone book located in the memory of the mobile communication device.

The method can also include storing a stored password in the memory of the mobile communication device, receiving a received password, comparing the received password to the stored password, determining the received password matches the stored password, and changing the status of the incoming message acceptance indicator if the received password matches the stored password. Receiving a received password can include receiving a received password on a user input of the mobile communication device. Changing the status can include changing the status of the incoming message acceptance indicator to indicate an incoming message non-filtering status. The phone number of the originator can be a call-back telephone number included with the incoming messaging service based message. Comparing can include iteratively comparing the phone number of the originator of the messaging service based message with each of the at least one phone number stored in the phone book located in the memory of the mobile communication device and stopping the iteratively comparing if the phone number of the originator matches an phone number of the at least one phone number stored in the phone book located in the memory of the mobile communication device. The method can also include receiving a private message acceptance status indicator change code and changing the status of the message acceptance indicator in response to receiving the private message acceptance status indicator change code. The incoming messaging service based message can be a short messaging service message, an enhanced messaging service message, or a multimedia messaging service message.

According to another embodiment, the present disclosure provides a mobile communication device. The mobile communication device can include a mobile communication device housing, a transceiver coupled to the mobile communication device housing, the transceiver configured to receive an incoming messaging service based message from a wireless messaging system, the incoming messaging service based message including a phone number of the originator of the messaging service based message, a display coupled to the mobile communication device housing, a memory coupled to the mobile communication device housing, the memory having an incoming message acceptance indicator, a message acceptance indicator change code, and an phone book including at least one phone number, and a controller coupled to the mobile communication device housing, the controller also coupled to the memory, the display, and the transceiver. The controller can be configured to set a status of the incoming message acceptance indicator to indicate an incoming message filtering status, compare the phone number of the originator of the messaging service based message with the phone book located in the memory of the mobile communication device, and display the incoming messaging service based message on the display only if the phone number of the originator is present in the phone book located in the memory of the mobile communication device.

The controller can be further configured to store a stored password in the memory of the mobile communication device, receive a received password, compare the received password to the stored password, determine the received password matches the stored password, and change the status of the incoming message acceptance indicator if the received password matches the stored password. The mobile communication device can also include a user input coupled to the housing and the controller can be further configured to receive the received password by receiving a received password on a user input of the mobile communication device. The controller can also be configured to change the status by changing the status of the incoming message acceptance indicator to indicate an incoming message non-filter status. The phone number of the originator can be a call-back telephone number included with the incoming messaging service based message.

The controller can additionally be configured to compare by iteratively comparing the phone number of the originator of the messaging service based message with each of the at least one phone number stored in the phone book located in the memory of the mobile communication device, and stopping the iteratively comparing if the phone number of the originator matches an phone number of the at least one phone number stored in the phone book located in the memory of the mobile communication device. The controller can also be configured to receive a private message acceptance status indicator change code and change the status of the message acceptance indicator in response to receiving the private message acceptance status indicator change code. The incoming messaging service based message can be a short messaging service message, an enhanced messaging service message, a multimedia messaging service message, or the like.

According to another embodiment, the present disclosure provides a mobile communication device. The mobile communication device can include a mobile communication device housing, a transceiver coupled to the mobile communication device housing, the transceiver configured to receive an incoming message from a wireless messaging system, the incoming messaging service based message including a phone number of the originator of the messaging service based message, a display coupled to the mobile communication device housing, a memory coupled to the mobile communication device housing, the memory having an incoming message acceptance indicator, a message indicator change code, and an phone book including at least one phone number, and a controller coupled to the mobile communication device housing, the controller also coupled to the memory, the display, and the transceiver. The controller can include a message acceptance indicator status set module configured to set a status of the incoming message acceptance indicator to indicate an incoming message filtering status and a phone number comparison module configured to compare the phone number of the originator of the messaging service based message with the phone book located in the memory of the mobile communication device. The controller can be configured to provide an alert, notification, or indicator of the incoming messaging service based message only if the phone number of the originator is present in the phone book located in the memory of the mobile communication device. For example, the controller can display an icon, can display the incoming message, can provide an audible alert, can provide a tactile alert, or can provide any other alert useful for notifying a user of an incoming message. The controller can also include a message display module configured to display the incoming messaging service based message on the display only if the phone number of the originator is present in the phone book located in the memory of the mobile communication device.

The incoming messaging service based message can be a short messaging service message, an enhanced messaging service message, a multimedia messaging service message, or the like. The controller can further include a status change module configured to receive a private message acceptance status indicator change code and change the status of the message acceptance indicator in response to receiving the private message acceptance status indicator change code. The phone number of the originator can be a call-back telephone number included with the incoming messaging service based message.

Thus, for example, all messaging control can be provided in a mobile communication device such as a mobile phone handset. Network involvement is not necessary for filtering incoming messaging service based messages. Also, control of enabling the feature can be provided at the device so a user can turn on or off the filter. The mobile communication device may also send a return messaging service message to a message originator notifying the originator that the message was not displayed.

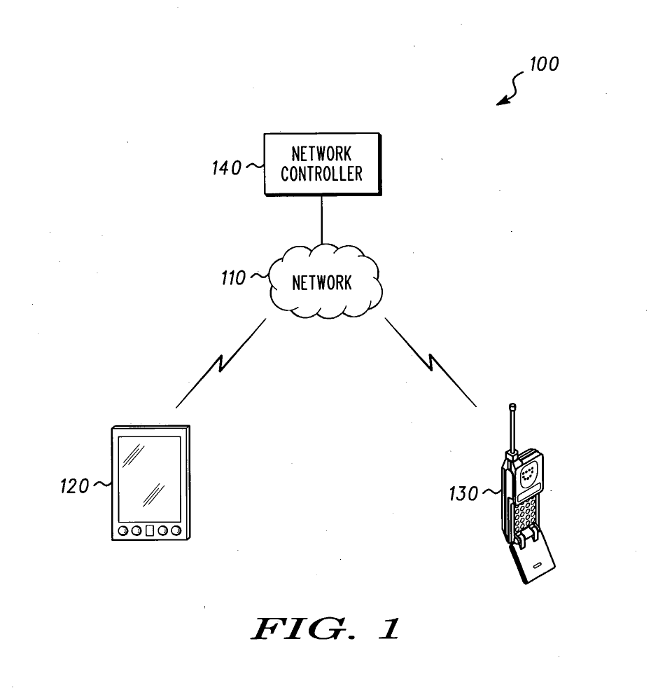

FIG. 1 is an exemplary block diagram of a system 100 according to one embodiment. The system 100 includes a network controller 140, a network 110, and one or more terminals 120 and 130. Terminals 120 and 130 may include telephones, wireless telephones, cellular telephones, PDAs, pagers, personal computers, or any other device that is capable of sending and receiving messaging service messages on a network including wireless network.

In an exemplary embodiment, the network controller 140 is connected to the network 110. The network 110 may include any type of wireless network that is capable of sending and receiving wireless messaging service messages. For example, the network 110 may include a wireless telecommunications network, a cellular telephone network, a satellite communications network, and other like communications systems capable of sending and receiving wireless messaging service messages. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving wireless messaging service messages.

In operation, terminals 120 and 130 can be used to send and receive messaging service messages. When a subscriber uses a terminal 130, for example, to send a messaging service message to another terminal 120, the communication signals can be routed by the network 110 through the network controller 140. The network controller 140 can determine a receiving terminal 120 and route the messaging service message to the receiving terminal 120 through the network 110. Upon receiving the message, the receiving terminal 120 can send a report to the network controller 140 confirming that the receiving terminal 120 has received the message.

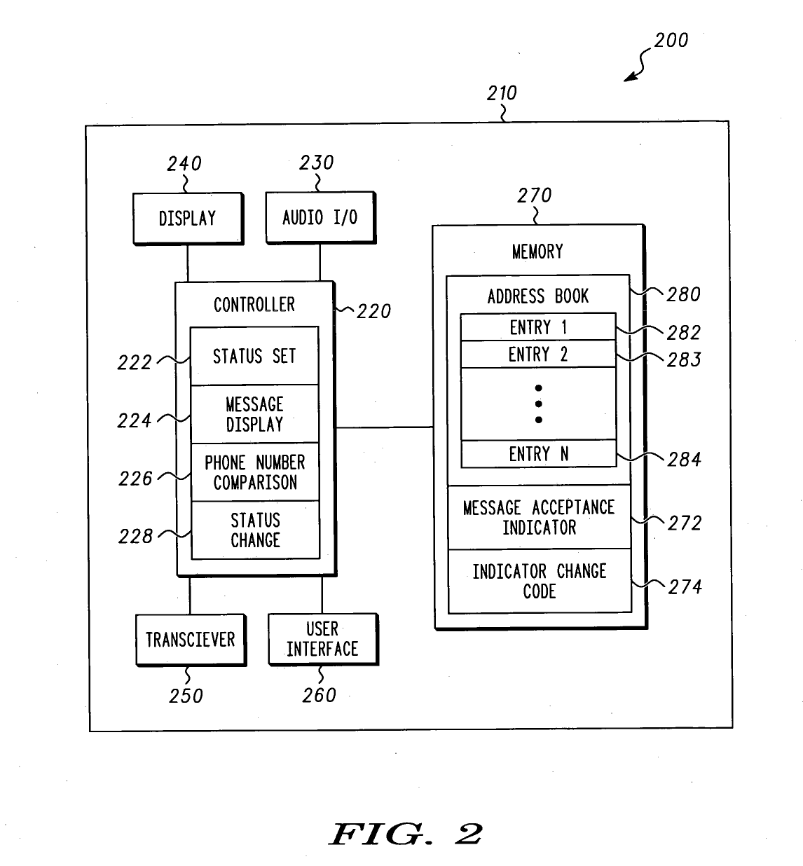

FIG. 2 is an exemplary block diagram of a mobile communication device 200, such as the terminal 120 or the terminal 130, according to one embodiment. The mobile communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, and a memory 270 coupled to the housing 210. The controller 220 can include a message acceptance indicator status set module 222, a message display module 224, a phone number comparison module 226, and a status change module 228. The modules 222, 224, 226, and/or 228 may be hardware coupled to the controller 220 or software located in the memory 270 and executed by the controller 220. The memory 270 can include an phone book 280 such as an address book or a contacts list, an incoming message acceptance indicator 272, and a message acceptance indicator change code 274. The phone book 280 can include phone book entries 282-284 including phone numbers corresponding to each entry 282-284. The incoming message acceptance indicator 272 may be a flag, a memory location, or any other indicator that can indicate an incoming message filtering status. The message acceptance indicator change code 274 can be a password, a private key, or any other code used for security when changing an indicator. The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and a electronic device. The memory 270 may include a random access memory, a read only memory, an optical memory, a subscriber identity module memory, or any other memory that can be coupled to a mobile communication device.

In operation, the transceiver 250 can receive an incoming messaging service based message from a wireless messaging system such as system 100. The incoming messaging service based message can include a phone number of the originator of the messaging service based message. The controller 220 can set a status of the incoming message acceptance indicator 272 to indicate an incoming message filtering status, compare the phone number of the originator of the incoming messaging service based message with phone numbers of entries 282-284 of the phone book 280, and display a notification of the incoming messaging service based message on the display 240 only if the phone number of the originator is present in the phone book 280. This notification may be an icon, a short message, the actual received message, or any other useful notification. If the incoming message acceptance indicator 272 is set to indicate an incoming message filtering status and the phone number of the originator of the incoming messaging service based message does not match a phone number in the phone book 280, the incoming messaging service based message is not displayed on the display 240. If the incoming message acceptance indicator 272 is not set to indicate an incoming message filtering status, the message is displayed on the display 240 regardless of whether the phone number of the originator of the incoming messaging service based message matches a phone number in the phone book 280. Also, regardless of whether the message is displayed or not, the controller 220 can send a report via the transceiver 250 confirming the incoming message was received. For example, this report may be sent to a service center using the network controller 140.

According to one embodiment, the controller 220 can store a stored password such as the message acceptance change code 274 in the memory 270 of the mobile communication device 200, receive a received password, compare the received password to the stored password, determine the received password matches the stored password, and change the status of the incoming message acceptance indicator 272 if the received password matches the stored password. The password can be received via a user input such as the user interface 260 of the mobile communication device 200 or through the transceiver 250.

According to another embodiment, a password specific to the incoming message acceptance indicator change code 274 must be entered to allow a user to change the incoming message acceptance indicator 272 from a filtering status to a non-filtering status or from a non-filtering status to a filtering status. This may be used, for example, for parental control of a minor's mobile communication device. Thus, the minor cannot receive obscene messages from an unknown source. This can also be used for security on the mobile communication device 200. According to another embodiment, the incoming message acceptance indicator 272 may be changed without using a message acceptance indicator change code 274.

The phone number of the originator can be a call-back telephone number included with the incoming messaging service based message. The controller 220 can compare the phone number of the originator of the incoming messaging service based message with the phone book 280 by iteratively comparing the phone number of the originator of the messaging service based message with each of the at least one phone number stored in the phone book 280, and stopping the iteratively comparing if the phone number of the originator matches an phone number of the at least one phone number stored in the phone book 280.

According to another embodiment, the controller 220 may employ the modules 222, 224 and 226 to perform functions of the mobile communication device 200. For example, the message acceptance indicator status set module 222 can set a status of the incoming message acceptance indicator 272 to indicate an incoming message filtering status. The phone number comparison module 226 can compare the phone number of the originator of the messaging service based message with the phone book 280. The message display module 224 can display the incoming messaging service based message on the display 240 only if the phone number of the originator is present in the phone book 280. The status change module 228 can receive a private message acceptance status indicator change code, compare the received code with a stored private message acceptance status indicator change code 274 and change the status of the message acceptance indicator 272 if the received code matches the stored code 274. The incoming messaging service based message can be a short messaging service message, an enhanced messaging service message, a multimedia messaging service message, or the like.

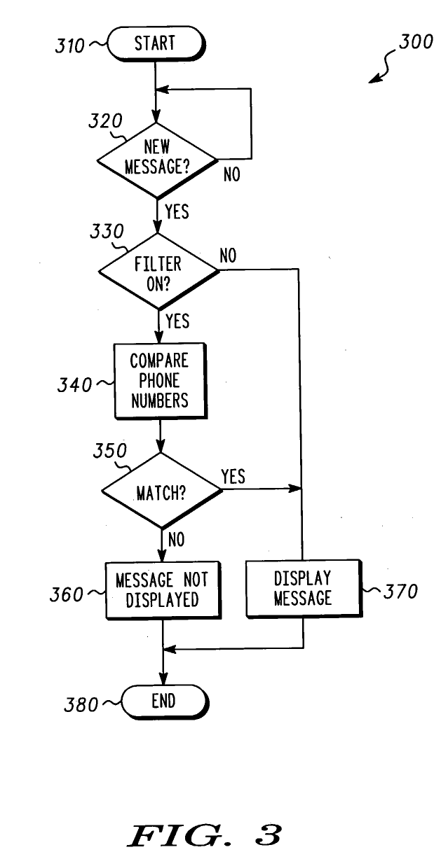

FIG. 3 is an exemplary flowchart 300 illustrating the operation of the mobile communication device 200 according to one embodiment. In step 310, the flowchart begins. In step 320, the mobile communication device 200 determines if a new messaging service based message has been received at the mobile communication device 200 from the system 100. If not, the mobile communication device 200 continues to wait for a message. If a message has been received, in step 330 the mobile communication device 200 determines if messages are being filtered. If not, the message or a new message indicator is displayed in step 370. If the messages are being filtered, in step 340, the mobile communication device 200 compares an originator phone number included with the message with phone numbers in the phone book 280. For example, the originator phone number may be a call back number included with the message. If there is a match, in step 370 the mobile communication device 200 displays the message or a new message indicator on the display 240. If there is no match, the mobile communication device 200 does not display the message or a new message indicator. It is not necessary to provide a notice that the message has not been displayed. For example, there may be no notification at all. In step 380, the flowchart 300 ends.

According to one embodiment, the originator number, such as a call-back number, can indicate the number to be dialed in reply to a received messaging service message. According to another embodiment, the originator number can also be a third-party call-back number used in reply to a messaging service broadcast message. According to another embodiment, the originator number can also be a call-back number subparameter that indicates the number to be dialed in reply to a received messaging service message. This subparameter can include a subparameter identifier field, a subparameter length field, a digit mode field, a number type field, a numbering plan field, a number of call-back number digits field, a call-back number digit or character field, and a reserved bits field. The subparameter identifier field can be set to 00001110. The subparameter length field can be set to the number of octets in the subparameter not including the subparameter identifier field and the subparameter length field. The digit mode indicator field can indicate whether the call-back number digits are 4-bit DTMF codes or 8-bit ASCII codes where the field can be set to 0 to specify the call-back number using the binary representation of DTMF digits and the field can be set to 1 to specify the call-back number using ASCII characters. The type of number field can correspond to the type of number if the call-back number is specified using DTMF digits. The numbering plan field can correspond to a requested numbering plan if the call-back number is specified using DTMF digits. The number of call-back number digits field can be set to the number of call-back number digits included in the subparameter. The call-back number digit or character field can include the digits or characters of a call-back number. The reserved bits field can contain the number of bits required to make the entire subparameter an integer number of octets in length.

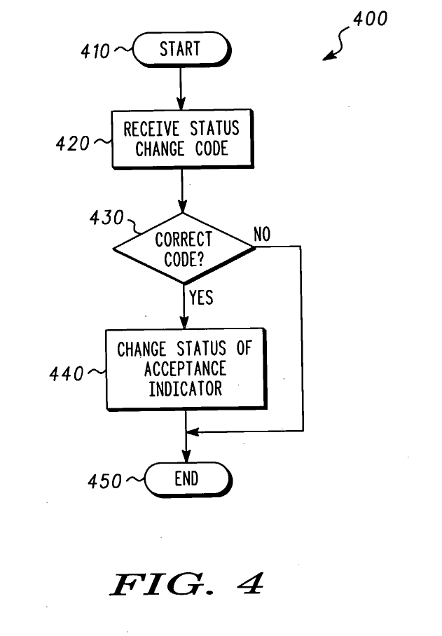

FIG. 4 is an exemplary flowchart 400 illustrating the operation of the mobile communication device 200 according to another embodiment. This flowchart 400 illustrates one example of how a message acceptance filter function can be toggled by a user by entering a security code and then enabling or disabling the function. In step 410, the flowchart begins. In step 420, the mobile communication device 200 receives a status change code such as a password. For example, the status change code may be received from a user via the user interface 260 or from the system 100 via the transceiver 250. In step 430, the mobile communication device 200 determines if the status change code is the correct code. For example, the mobile communication device 200 may compare the received status change code with the message acceptance indicator change code 274. If the status change code is the correct code, in step 440, the mobile communication device 200 changes the status of the incoming message acceptance indicator 272. For example, the status change code may toggle the incoming message acceptance indicator 272 between a filtering status and a non-filtering status. Alternatively, the status change code may act as a password that allows a user access to an interface for changing the status of the incoming message acceptance indicator 272. In step 450, the flowchart 400 ends.

The method of this invention is preferably implemented on a programmed processor. However, controller 220 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Accordingly, the preferred embodiments of the invention as set forth herein are intended to be illustrative, not limiting. Various changes may be made without departing from the spirit and scope of the invention.

What is claimed is:

1. A method of managing incoming messaging service based messages in a mobile communication device, the method comprising:
storing at least one phone number in a phone book located in the memory of the mobile communication device;
setting a status of an incoming message acceptance indicator in the mobile communication device to indicate an incoming message filtering status;
receiving an incoming messaging service based message from a wireless messaging system, the incoming messaging service based message including a phone number of the originator of the messaging service based message;
comparing the phone number of the originator of the messaging service based message with the phone book located in the memory of the mobile communication device; and
displaying at least one of the incoming messaging service based message and a new message notification only if the phone number of the originator is present in the phone book located in the memory of the mobile communication device.

2. The method according to claim 1, further comprising:
storing a stored password in the memory of the mobile communication device;
receiving a received password;
comparing the received password to the stored password;
determining the received password matches the stored password; and
changing the status of the incoming message acceptance indicator if the received password matches the stored password.

3. The method according to claim 2, wherein receiving a received password includes receiving a received password on a user input of the mobile communication device.

4. The method according to claim 2, wherein changing the status includes changing the status of the incoming message acceptance indicator to indicate an incoming message non-filtering status.

5. The method according to claim 1, wherein the phone number of the originator is a call-back telephone number included with the incoming messaging service based message.

6. The method according to claim 1, wherein comparing includes
iteratively comparing the phone number of the originator of the messaging service based message with each of the at least one phone number stored in the phone book located in the memory of the mobile communication device, and
stopping the iteratively comparing if the phone number of the originator matches an phone number of the at least one phone number stored in the phone book located in the memory of the mobile communication device.

7. The method according to claim 1, further comprising:
receiving a private message acceptance status indicator change code; and
changing the status of the message acceptance indicator in response to receiving the private message acceptance status indicator change code.

8. The method according to claim 1, wherein the incoming messaging service based message comprises at least one of a short messaging service message, and enhanced messaging service message, and a multimedia messaging service message.

9. A mobile communication device comprising:
a mobile communication device housing;
a transceiver coupled to the mobile communication device housing, the transceiver configured to receive an incoming messaging service based message from a wireless messaging system, the incoming messaging service based message including a phone number of the originator of the messaging service based message;
a display coupled to the mobile communication device housing;
a memory coupled to the mobile communication device housing, the memory having an incoming message acceptance indicator, a message acceptance indicator change code, and a phone book including at least one phone number; and
a controller coupled to the mobile communication device housing, the controller also coupled to the memory, the display, and the transceiver, the controller configured to set a status of the incoming message acceptance indicator to indicate an incoming message filtering status, compare the phone number of the originator of the incoming messaging service based message with the phone book located in the memory of the mobile communication device, and display the incoming messaging service based message on the display only if the phone number of the originator is present in the phone book located in the memory of the mobile communication device.

10. The mobile communication device according to claim 9, wherein the controller is further configured to store a stored password in the memory of the mobile communication device, receive a received password, compare the received password to the stored password, determine the received password matches the stored password, and change the status of the incoming message acceptance indicator if the received password matches the stored password.

11. The mobile communication device according to claim 10, further comprising a user input coupled to the housing,
wherein the controller is further configured to receive the received password by receiving a received password on a user input of the mobile communication device.

12. The mobile communication device according to claim 10, wherein the controller is further configured to change the status by changing the status of the incoming message acceptance indicator to indicate an incoming message non-filter status.

13. The mobile communication device according to claim 9, wherein the phone number of the originator is a call-back telephone number included with the incoming messaging service based message.

14. The mobile communication device according to claim 9, wherein the controller is further configured to compare by iteratively comparing the phone number of the originator of the messaging service based message with each of the at least one phone number stored in the phone book located in the memory of the mobile communication device, and stopping the iteratively comparing if the phone number of the originator matches an phone number of the at least one phone number stored in the phone book located in the memory of the mobile communication device.

15. The mobile communication device according to claim 9, wherein the controller is further configured to receive a private message acceptance status indicator change code and change the status of the message acceptance indicator in response to receiving the private message acceptance status indicator change code.

16. The mobile communication device according to claim 9, wherein the incoming messaging service based message comprises at least one of a short messaging service message, an enhanced messaging service message, and a multimedia messaging service message.

17. A mobile communication device comprising:
a mobile communication device housing;
a transceiver coupled to the mobile communication device housing, the transceiver configured to receive an incoming message from a wireless messaging system, the incoming messaging service based message including a phone number of the originator of the messaging service based message;
a display coupled to the mobile communication device housing;
a memory coupled to the mobile communication device housing, the memory having an incoming message acceptance indicator, a message indicator change code, and a phone book including at least one phone number; and
a controller coupled to the mobile communication device housing, the controller also coupled to the memory, the display, and the transceiver, the controller including
a message acceptance indicator status set module configured to set a status of the incoming message acceptance indicator to indicate an incoming message filtering status, and
a phone number comparison module configured to compare the phone number of the originator of the messaging service based message with the phone book located in the memory of the mobile communication device,
wherein the controller is configured to provide an alert of the incoming messaging service based message only if the phone number of the originator is present in the phone book located in the memory of the mobile communication device.

18. The mobile communication device according to claim 17, further comprising a message display module configured to display the incoming messaging service based message on the display only if the phone number of the originator is present in the phone book located in the memory of the mobile communication device.

19. The mobile communication device according to claim 18,
wherein the message display module is further configured to not display the incoming messaging service based message on the display if the phone number of the originator is not present in the phone book located in the memory of the mobile communication device, and
wherein the transceiver sends a report confirming the incoming message was received when the phone number of the originator is not present in the phone book located in the memory of the mobile communication device and when the incoming message is not displayed on the display.

20. The mobile communication device according to claim 17, wherein the controller is configured to send a return messaging service message to a message originator notifying the originator that the incoming message was not displayed.

21. The mobile communication device according to claim 17, wherein the incoming messaging service based message comprises at least one of a short messaging service message, an enhanced messaging service message, and a multimedia messaging service message.

22. The mobile communication device according to claim 17, wherein the controller further includes a status change module configured to receive a private message acceptance status indicator change code and change the status of the message acceptance indicator in response to receiving the private message acceptance status indicator change code.

23. The mobile communication device according to claim 17, wherein the phone number of the originator is a call-back telephone number included with the incoming messaging service based message.
